(19) United States
(12) Patent Application Publication
(10) Pub. No.: US 2020/0143727 A1
(43) Pub. Date: May 7, 2020

(54) DISPLAY DRIVING CIRCUIT AND DISPLAY DEVICE

(71) Applicants: HKC Corporation Limited, Shenzhen (CN); Chongqing HKC Optoelectronics Technology Co., Ltd., Chongqing (CN)

(72) Inventor: Wenxin Li, Shenzhen (CN)

(21) Appl. No.: 16/292,358

(22) Filed: Mar. 5, 2019

Related U.S. Application Data
(63) Continuation of application No. PCT/CN2018/115780, filed on Nov. 16, 2018.

(30) Foreign Application Priority Data
Nov. 5, 2018 (CN) 201821813112.9

(51) Int. Cl. G09G 3/20

(52) U.S. Cl. CPC G09G 3/20; G09G 2310/0278; G09G 2310/08; G09G 2310/0248

(57) ABSTRACT

Disclosed are a display driving circuit and a display device. The display driving circuit includes a plurality of scan signal output circuits, the plurality of scan signal output circuits output scan driving signals to corresponding row signal lines, according to control signals of a timing sequence control circuit, to drive display units on the row signal lines; and each of the scan signal output circuits includes a signal output control circuit, and output duration of the scan driving signal is extended by the control of the signal output control circuit, when the scan driving signal is output for a row signal line of a preset row.

### CROSS-REFERENCE TO RELATED APPLICATIONS

The present disclosure is a Continuation Application of PCT Application No. PCT/CN2018/115780, filed Nov. 16, 2018, which claims the benefit of Chinese Patent Application No. 201821813112.9, filed Nov. 5, 2018 with the State Intellectual Property Office and entitled “Display Driving Circuit and Display Device”, the entirety of which is hereby incorporated herein by reference.

### FIELD

The present disclosure relates to the field of display panel technology, and more particularly relates to a display driving circuit and a display device.

### BACKGROUND

The statements herein merely provide background information related to the present disclosure, and do not necessarily constitute the prior art.

The display device, such as the thin film transistor liquid crystal display (TFT-LCD), has become an indispensable part in modern IT and video products. With the increasing demand for large size and high resolution of the display device, more and more driving lines are arranged in the display device. As such, under the condition that the scan time of one frame is fixed, a precharging technology is used in which the display pixels are charged in advance, so as to guarantee the charging time of display pixels on the signal line of each row.

However, the current precharging technology cannot guarantee that the display pixels on the signal line of each row are precharged, which is a problem pending to be solved.

### SUMMARY

The present disclosure provides a display driving circuit and a display device, ensuring a precharging for display pixels on each row signal line, during the display driving process.

The present disclosure provides a display driving circuit. The display driving circuit includes a plurality of scan signal output circuits, the plurality of scan signal output circuits output scan driving signals to corresponding row signal lines, according to control signals of a timing sequence control circuit, to drive display units on the row signal lines; and

each of the scan signal output circuits includes a signal output control circuit, and output duration of the scan driving signal is extended by the control of the signal output control circuit, when the scan driving signal is output for a row signal line of a preset row.

Optionally, the row signal line of the preset row is a preset number of row signal line which start from the first row.

Optionally, the signal output control circuit includes:

a signal trigger circuit, including two input ends and an output end, the two input ends respectively receiving the scan driving signal and a first control signal, and outputting the scan driving signal when the first control signal satisfies a triggering condition; and

a first logic circuit, including two input ends and an output end, one input end being connected to an output end of the signal trigger circuit, the other input end receiving a second control signal, the logic unit outputting a calculated scan driving signal which is obtained by a logical operation of the scan driving signal output by the signal trigger circuit and the second control signal.

Optionally, the first logic circuit is a logic OR gate, in the signal output control circuit connected to the row signal line of the preset row.

Optionally, the first logic circuit is a logic AND gate, in the signal output control circuit connected to the row signal line on any of the remaining rows.

Optionally, the signal trigger circuit includes at least one trigger integrated circuit, the trigger integrated circuit outputs the received scan driving signal, when the trigger integrated circuit receives the first control signal, and the first control signal is at a rising edge.

Optionally, the signal trigger circuit is a D flip-flop.

Optionally, the second control signal is an enable signal, and configured to control output of the scan driving signal.

Optionally, the first control signal is a clock signal.

Optionally, the received scan driving signal is a frame start signal, in the signal output control circuit connected to the row signal line of the first row; the received scan driving signal is the scan driving signal output by the signal trigger circuit in the previous signal output control circuit, in each of the signal output control circuits connected to the row signal lines of the remaining rows.

Optionally, each of the scan signal output circuits further includes a second logic circuit, the second logic circuit receives a third control signal and the scan driving signal, and outputs a calculated signal which is obtained by a logical operation of the third control signal and the scan driving signal.

Optionally, the third control signal is a row scan direction control signal.

The present disclosure further provides a display driving circuit. The display driving circuit includes a plurality of scan signal output circuits, the of plurality of scan signal output circuits output scan driving signals to corresponding row signal lines, according to a control signal of a time sequence control circuit, to drive display pixels on the row signal lines; the plurality of scan signal output circuits are connected to the row signal lines correspondingly, and the scan signal output circuits, which are connected to four row signal lines starting from the first row, are first scan signal output circuits, the scan signal output circuits, which are connected to the row signal lines on the remaining rows, are second scan signal output circuits; and

each of the scan signal output circuit includes a signal output control circuit, and by the control of the signal output control circuit, output duration of the scan driving signal output by the first scan signal output circuit is longer than the output duration of the scan driving signal output by the second scan signal output circuit, when the scan signal output circuit outputs the scan driving signal to the row signal line.

Optionally, the signal output control circuit includes:

a signal trigger circuit, including two input ends and an output end, the two input ends respectively receiving the scan driving signal and a first control signal, and outputting the scan driving signal when the first control signal satisfies a triggering condition; and

a first logic circuit, including two input ends and an output end, one input end being connected to an output end of the signal trigger circuit, the other input end receiving a second control signal, the logic unit outputting a calculated scan driving signal which is obtained by a logical operation of the scan driving signal output by the signal trigger circuit and the second control signal.

Optionally, the first logic circuit is a logic OR gate, in the signal output control circuit connected to the row signal line of the preset row.

Optionally, the first logic circuit is a logic AND gate, in the signal output control circuit connected to the row signal line on any of the remaining rows.

The present disclosure further provides a display device. The display device includes

a substrate, the substrate being defined with a display area and a non-display area, the display area being defined with a plurality of display pixels therein; and

a display driving device, configured to drive the display pixels for display, the display driving device including a plurality of scan signal output circuits, the plurality of scan signal output circuits outputting scan driving signals to corresponding row signal lines, to drive the display pixels on the row signal lines, according to the control signals of a timing sequence control circuit; each of the scan signal output circuits including a signal output control circuit, and by the control of the signal output control circuit, output duration of the scan driving signal being extended, when the scan driving signal is output for a row signal line of a preset row.

Optionally, the display driving device includes a driving controller, a scan driving circuit and a data driving circuit, the driving controller outputs a driving control signal, to control the scan driving circuit and the data driving circuit to output corresponding driving signals, to drive the display pixels to work.

Optionally, the scan driving circuit outputs the scan driving signal, and the scan driving signal is output to the row signal line via the scan signal output circuit.

Optionally, the driving controller outputs the control signal, and the control signal is output to the scan signal output circuit, to control output of the scan driving signal.

In the embodiments of the present disclosure, by controlling the output duration of the scan driving signal, the charging time for the display pixels, which are on the row signal lines and unable to be precharged, is increased, guaranteeing the charging effect of the display pixels on each row signal line, further making the brightness of the display more uniform.

### BRIEF DESCRIPTION OF THE DRAWINGS

FIG. 1 is a structural diagram of a display device of an embodiment according to the present disclosure;

FIG. 2 is a functional module diagram of a display driving circuit of an embodiment according to the present disclosure;

FIG. 3 is a logical structure diagram of a display driving circuit of an embodiment according to the present disclosure;

FIG. 4 is a signal waveform diagram of the display driving circuit driving the row signal lines of an embodiment according to the present disclosure;

FIG. 5 is a logic structure diagram of a display driving circuit of another embodiment according to the present disclosure.

### DETAILED DESCRIPTION OF THE EMBODIMENTS

In order to better understand the above-described technical solutions, exemplary embodiments of the present disclosure will be described in more detail below with reference to the accompanying drawings. It should be understood that, the present disclosure may be embodied in various forms and should not be limited by the embodiments set forth herein. Rather, these embodiments are provided so that the present disclosure will be more fully understood, and the scope of the present disclosure can be fully conveyed to those skilled in the art.

It should be understand that, all directional indications (such as “upper”, “lower”, “left”, “right”, “front”, “back” . . . ) in the embodiments of the present disclosure are only used to explain the relative positional relationship, motion, and the like, between components in a certain posture. If the particular posture changes, the directional indication changes accordingly.

Moreover, terms such as “first” and “second” are used herein for purposes of description and are not intended to indicate or imply relative importance or to imply the number of indicated technical features. Thus, the features defined with “first” and “second” may comprise or imply at least one of these features. In addition, the technical solutions between the various embodiments of the present disclosure may be combined with each other, but must be based on the realization of those skilled in the art. When the combination of technical solutions is contradictory or impossible to implement, it should be considered that the combination of the technical solutions does not exist, and not within the scope of protection required by this disclosure.

In order to solve the technical problem that the existing display driving way is unable to meet the requirements of large-size and high-resolution of the display device, the present disclosure provides a new display driving way, which ensures the charging effect of all display pixels in the display device, and realizes uniform brightness of the display device, during the display driving process.

To facilitate the understanding of the embodiments of the present disclosure, before describing the specific embodiments of the present disclosure, the driving principle of the display device of an embodiment structure is briefly introduced.

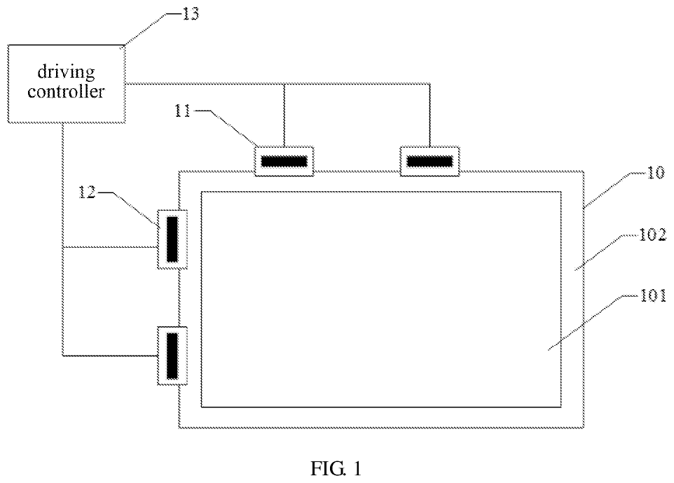

Referring to FIG. 1, FIG. 1 is a structural diagram of a display device of an embodiment according to the present disclosure. The display device includes a substrate 10, and a display driving device 11. Specifically,

An display area 101 and a non-display area 102 are provided on the substrate 10. The display area 101 includes a plurality of display units, the plurality of display units may be arranged in rows and columns to form a matrix structure. Of course, the plurality of display units are not limited to be arranged in the form of the matrix structure, and could also be in other arrangement structures. Each display unit includes at least one display pixel.

Optionally, the display area 101 is also provided with signal lines arranged crosswise and switch components. Specifically, the signal lines may include first signal lines and second signal lines, which are electrically connected to the switch components. The switch component is activated, when the switch component receives a scan driving signal from the first signal line. In this case, display pixels receive a data signal from the second signal line via the activated switch component, and are illuminated according to the data signal. Specifically, the above-mentioned switch component may include, but is not limited to, a thin film transistor (TFT), for example, a field effect transistor, a triode, and so on. The first signal line and the second signal line described above may also be referred to as a scan line and a data line.

Specifically, the display driving device may include a driving controller 11, a scan driving circuit 12, and a data driving circuit 13. The driving controller 11 outputs a driving control signal, to control the scan driving circuit 12 and the data driving circuit 13 to output corresponding driving signals, so as to drive display pixels to work. Specifically, the scan driving circuit 12 outputs the scan driving signal line by line. If the display pixels of the current row receive the scan driving signal, the corresponding switch components are activated. The display pixels of the current row receive the data signal output by the data driving circuit 13 via the activated switching components. The data signal is transmitted to the display pixels of the current row via the activated switch components, so as to charge the display pixels of the current row, thereby driving the display pixels of the current row to be lit up. And so on, after the display driving device driving the display pixels of all the rows by line-by-line scanning or interlaced scanning, the updating of one frame is completed.

The display driving device of the embodiment according of the present disclosure adopts the precharging technology, that is, while the row driving circuit 12 is controlled to output the row driving signal to the current row signal line, the row driving signal is also output to another row signal line (hereinafter referred to as the precharged row signal line), so that both the switch components on the current row signal line and the switch components on the precharged row signal line could be activated, and the data signal is transmitted to the display pixels on the current row signal line and the display pixels on the precharged row signal line via the activated switch components. As such, the data signal charges the display pixels on the signal line of the current row, and when the charging voltage reaches the driving voltage of the display pixels, the display pixels of the current row are driven to light up. And the rest of the data signal precharges the display pixels on the precharged row signal line, that is, the voltage on the display pixels on the precharged row signal lines reaches a certain value (but it is not enough to drive the display pixels on the current row to light up). When the scan driving circuit 12 scans the precharged row signal line, the charging voltage on the precharged row signal line could quickly reach the voltage that could drive the display pixels to light up, thus achieving the goal of quickly driving the display pixels to light up.

In the above precharging technology adopted by the display device, the reaction speed of display pixels is improved. However, when performing display driving, it is often impossible to precharge the first row or rows scanned, so that the charging effect of display pixels on the row signal lines that cannot be precharged is poor, thus making the screen display uniform.

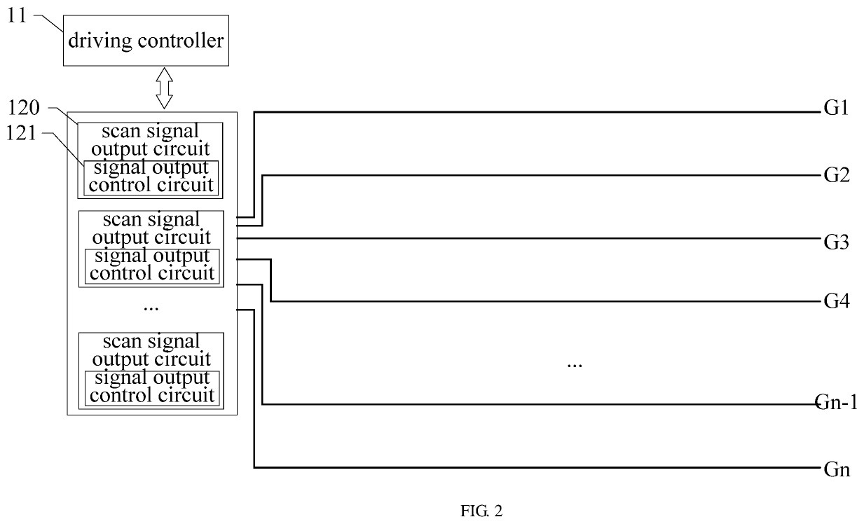

In this regard, referring to FIG. 2, FIG. 2 is a functional module diagram of a display driving circuit of an embodiment according to the present disclosure. The display driving circuit, which is proposed in the technical solution of the present disclosure, includes a plurality of scan signal output circuits 120. Each of the scan signal output circuits 120 is electrically connected to the driving controller 11, and is configured to receive the control signal output by the driving controller 11, then output the scan driving signal to the row signal line, according to the control signal output by the driving controller 11, so as to scan the display units on the driving row signal line. Each of the scan signal output circuits 120 includes the signal output control circuit 121, and output duration of the scan driving signal is extended, by the control of the signal output control circuit 121, when the scan driving signal is output for a row signal line of a preset row.

Specifically, the plurality of scan signal output circuits 120 are connected to the row signal lines by one-to-one correspondence. The scan signal output circuit connected to the row signal line of the preset row is defined as a first scan signal output circuit, and the scan signal output circuit connected to the row signal line on any of the remaining rows is defined as a second scan signal output circuit. Under the control of the signal control unit 121, the output duration of the scan driving signal output by the first scan signal output circuit is longer than the output duration of the scan driving signal output by the second scan signal output circuit.

According to the embodiment of the present disclosure, by controlling the output duration of the scan driving signal, the charging time for the display pixels, which are on the row signal lines and unable to be precharged, is increased, so that the charging effect of the display pixels on each row signal line is guaranteed, making the brightness of the display more uniform.

Optionally, the control signals output by the driving controller may include a frame start signal STV, a clock signal CPV, a scan direction control signal L/R, an enable signal OE, and the like. The frame start signal STV is a start signal of starting a frame. The scan direction control signal L/R controls the row scan direction, for example, from top to bottom, or from bottom to top. The enable signal OE is configured to control the output of the scan driving signal, for example, when the OE signal is at a high level, the scan driving signal is output, and when the OE signal becomes a low level, the output of the scan driving signal is stopped. Each scan signal output circuit 120 is controlled to output the scan driving signal to the corresponding row signal line, by the control signals output by the driving controller.

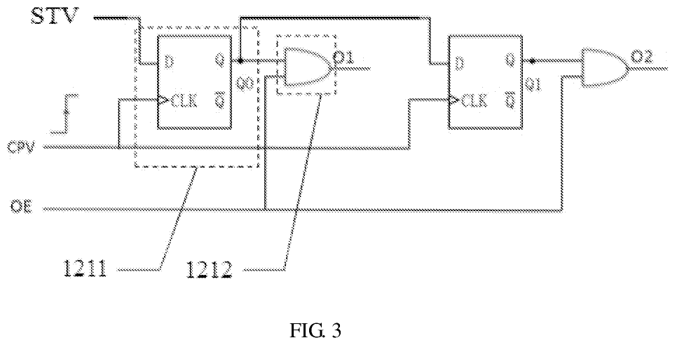

Optionally, in some embodiments, referring to FIG. 3, FIG. 3 is a logical structure diagram of a display driving circuit of an embodiment according to the present disclosure. The signal output control circuit 121 includes:

a signal trigger circuit 1211, comprising two input ends and an output end, the two input ends respectively receiving the scan driving signal and a first control signal, and outputting the scan driving signal when the first control signal satisfies a triggering condition; and

a first logic circuit 1212, including two input ends and an output end, one input end being connected to an output end of the signal trigger circuit, the other input end receiving a second control signal, the logic unit outputting a calculated scan driving signal which is obtained by a logical operation of the scan driving signal output by the signal trigger circuit and the second control signal.

Specifically, the signal trigger circuit 1211 includes at least one trigger integrated circuit, such as a D flip-flop. The signal trigger circuit 1211 outputs the received scan driving signal, when the signal trigger circuit 1221 receives the first control signal and the first control signal satisfies the trigger condition. Taking the D flip-flop as an example, the trigger condition of the D flip-flop is rising edge-triggered, that is, when the first control signal is received and the first control signal is at the rising edge, the D flip-flop is triggered and outputs the scan driving signal. Alternatively, the signal triggering circuit may also include other types of flip-flop that implement the same function, and the flip-flops may adopt other trigger conditions, such as falling edge-triggered, and so on.

The first logic circuit 1212 includes at least one logic gate, such as a logic AND gate, a logic OR gate, a NAND gate, a NOT gate, and the like. By the logical operation of the received scan driving signal and the second control signal performed by the logic gate circuit, the logic level and the output duration of the scan driving signal are under control.

Further, in the signal output control circuits 121 connected to the row signal lines of the preset rows, the first logic circuits 1212 are logic OR gates. And in the signal output control circuits 121 connected to the row signal lines on the remaining rows, the first logic circuits 1212 are logic AND gates. By setting the first logic circuits of different logic circuits, the output durations of the scan driving signals are controlled, so that the charging time for the display pixels, which are on the row signal lines of the preset rows and unable to be precharged, is increased, guaranteeing the charging effect of the display pixels on each row signal line, further making the brightness of the display more uniform.

Optionally, in the signal output control circuit 121 connected to the row signal line of the first row, the received scan driving signal is the frame start signal STY. And in the signal output control circuit 121 connected to the row signal line of any of the remaining rows, the received scan driving signal is the scan driving signal output by the signal trigger circuit 1211 in the previous signal output control circuit 121. As such, the driving controller 11 only needs to output one scan driving signal, and by the shift transmission of the scan driving signal, the scan driving of the row signal lines of all rows is realized, which not only saves the driving lines, but also simplifies the driving logic.

Further, the row signal lines of the preset rows are row signal lines of a preset number which start from the first row. In some embodiments, for example, the preset number is 4. Of course, the preset number could be 1, 2, or other numbers. The preset number is mainly determined according to the number of the row signal lines that cannot be precharged.

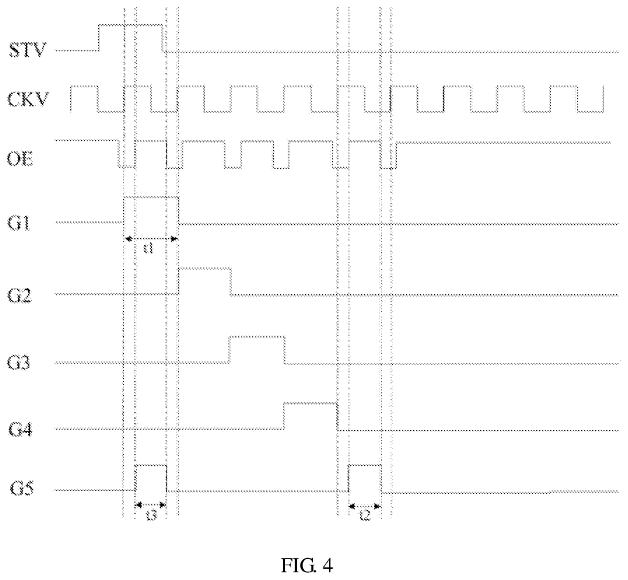

Referring to FIGS. 3 and 4, FIG. 4 is a signal waveform diagram of the display driving circuit driving the row signal lines of an embodiment according to the present disclosure.

The driving controller 11 outputs the frame start signal STV, and controls the scan driving circuit 12 to perform the line scanning by the frame start signal STV

When the frame start signal STV is at a high level, the driving controller 11 controls the scan driving circuit 12 to output the scan driving signal, to activate the switch components on the row signal line by line-by-line driving or interlaced driving, and the charging signal output by the data driving circuit 13 charges the display pixels on the row signal line via the activated switch components. In addition, while the scan driving circuit 12 charges the display pixels on the row signal line of the first row, the scan driving signal also activates the switch components on the row signal line of the fifth row, therefore, the charging signal output by the data driving circuit 13 also precharges the display pixels on the row signal line of the fifth row. And so on, until the display pixels on all the row signal lines have been charged, scanning and refreshing of a frame is completed.

When the scan driving circuit 12 outputs the scan driving signal, in the signal output control circuit 121 connected to the row signal line of the preset row, the calculated scan driving signal, which is obtained by the logical OR operation of the scan driving signal output by the signal trigger circuit 1211 and the OE signal, is output. Therefore, in the scan driving signal output by the signal output control circuit connected to the row signal line of the preset row, the output duration starts from the rising edge of the clock signal CKV and continues until the rising edge of the next clock signal CKV. For example, the duration of the scan driving signal output to the row signal line G1 of the first row is t1.

In the signal output control circuit 121 connected to the row signal line of any of the other rows, the calculated scan driving signal, which is obtained by the logical AND operation of the scan driving signal output by the signal trigger circuit 1211 and the OE signal, is output. Therefore, among the scan driving signals output by the signal output control circuit connected to the row signal lines of the other rows, the output duration coincides with the high-level duration of the OE signal. That is, if the OE signal outputs a high level, the scan driving signal is output; if the OE signal outputs a low level, the output of the scan driving signal is stopped. For example, the duration of the scan driving signal output to the row signal line G5 of the fifth row is t2.

In addition, in the signal output control circuits 121 connected to the row signal lines of other rows, after the logical OR operation of the scan driving signal output by the signal trigger circuit 1211 and the OE signal, the calculated scan driving signal is output. Therefore, when the drive controller 11 controls the scan driving circuit 12 to scan the row signal line of another row, to allow the data driving circuit 13 to precharge the row signal line of another row, the output duration of the scan driving signal output by the scan driving circuit 12 coincides with the duration of the high level of the OE signal. For example, the duration of the scan driving signal output to the row signal line G5 of the fifth row is t3, during the precharging.

As can be seen from the above, because the row signal lines of the preset rows cannot be precharged, according to the technical solution of the present disclosure, the on time of the switch components on the row signal lines of the preset rows is prolonged, so that the charging time of the display pixels of the preset rows is prolonged, and the display effect of the display pixels of all the row signal lines is further ensured.

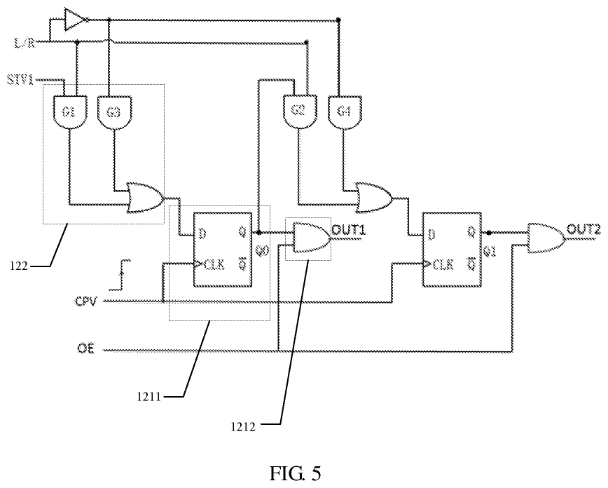

Further, referring to FIG. 5, FIG. 5 is a logic structure diagram of a display driving circuit of another embodiment according to the present disclosure. Each scan signal output circuit 120 further includes a second logic circuit 122. The second logic circuit 122 receives a third control signal and the scan driving signal, and outputs a calculated signal which is obtained by a logical operation of the third control signal and the scan driving signal.

Specifically, the second logic circuit 122 includes at least one logic gate circuit, such as a logic AND gate, a logic OR gate, a NAND gate, a NOT gate, and the like. The third control signal is the line scan direction control signal L/R. The line scan control signal controls whether the frame scan starts from the first line or from the last line, when the frame scan starts. For example, when L/R is at a high level, scanning starts from the first row, and when L/R is a low level, scanning starts from the last row.

It should be noted that, in the claims, any reference signs placed between parentheses shall not be construed as limiting the claims. The word “comprising” does not exclude the presence of the components or steps that are not recited in the claims. The word “a” or “an” before a part does not preclude the existence of multiple such parts. The present disclosure could be implemented by means of hardware including several distinct components, and by means of a suitably programmed computer. In the unit claims enumerating several devices, several of these devices could be embodied by a same hardware item. The use of the words first, second, and third does not indicate any order, and these words could be interpreted as names.

Although alternative embodiments of the present disclosure have been described, those skilled in the art could make additional changes and modifications to the embodiments once they become aware of the basic inventive concept. Therefore, the appended claims are intended to be construed as including all alternatives and modifications.

It will be appreciated that, various modifications and variations could be made in the present disclosure by those skilled in the art without departing from the spirit and scope of the present disclosure. In this way, if these modifications and variations of the present disclosure fall within the scope of the claims of the present disclosure and its equivalent technologies, the present disclosure also intends to include such modifications and variations.

What is claimed is:

1. A display driving circuit, wherein, the display driving circuit comprises a plurality of scan signal output circuits, the plurality of scan signal output circuits output scan driving signals to corresponding row signal lines, according to control signals of a timing sequence control circuit, to drive display units on the row signal lines; and
each of the scan signal output circuits comprises a signal output control circuit, and output duration of the scan driving signal is extended by the control of the signal output control circuit, when the scan driving signal is output for a row signal line of a preset row.

2. The display driving circuit of claim 1, wherein, the row signal line of the preset row is a preset number of row signal line which start from the first row.

3. The display driving circuit of claim 1, wherein, the signal output control circuit comprises:
a signal trigger circuit, comprising two input ends and an output end, the two input ends respectively receiving the scan driving signal and a first control signal, and outputting the scan driving signal when the first control signal satisfies a triggering condition; and
a first logic circuit, comprising two input ends and an output end, one input end being connected to an output end of the signal trigger circuit, the other input end receiving a second control signal, the logic unit outputting a calculated scan driving signal which is obtained by a logical operation of the scan driving signal output by the signal trigger circuit and the second control signal.

4. The display driving circuit of claim 3, wherein, the first logic circuit is a logic OR gate, in the signal output control circuit connected to the row signal line of the preset row.

5. The display driving circuit according to claim 4, wherein, the first logic circuit is a logic AND gate, in the signal output control circuit connected to the row signal line on any of the remaining rows.

6. The display drive circuit of claim 3, wherein, the signal trigger circuit comprises at least one trigger integrated circuit, the trigger integrated circuit outputs the received scan driving signal, when the trigger integrated circuit receives the first control signal, and the first control signal is at a rising edge.

7. The display drive circuit of claim 3, wherein, the signal trigger circuit is a D flip-flop.

8. The display drive circuit of claim 3, wherein, the second control signal is an enable signal, and configured to control output of the scan driving signal.

9. The display driving circuit of claim 3, wherein, the first control signal is a clock signal.

10. The display drive circuit of claim 3, wherein, the received scan driving signal is a frame start signal, in the signal output control circuit connected to the row signal line of the first row; the received scan driving signal is the scan driving signal output by the signal trigger circuit in the previous signal output control circuit, in each of the signal output control circuits connected to the row signal lines of the remaining rows.

11. The display drive circuit of claim 10, wherein, each of the scan signal output circuits further comprises a second logic circuit, the second logic circuit receives a third control signal and the scan driving signal, and outputs a calculated signal which is obtained by a logical operation of the third control signal and the scan driving signal.

12. The display driving circuit of claim 11, wherein, the third control signal is a row scan direction control signal.

13. A display driving circuit, wherein, the display driving circuit comprises a plurality of scan signal output circuits, the of plurality of scan signal output circuits output scan driving signals to corresponding row signal lines, according to a control signal of a time sequence control circuit, to drive display pixels on the row signal lines; the plurality of scan signal output circuits are connected to the row signal lines correspondingly, and the scan signal output circuits, which are connected to four row signal lines starting from the first row, are first scan signal output circuits, the scan signal output circuits, which are connected to the row signal lines on the remaining rows, are second scan signal output circuits; and
each of the scan signal output circuit comprises a signal output control circuit, and by the control of the signal output control circuit, output duration of the scan driving signal output by the first scan signal output circuit is longer than the output duration of the scan driving signal output by the second scan signal output circuit, when the scan signal output circuit outputs the scan driving signal to the row signal line.

14. The display driving circuit according to claim 13, wherein, the signal output control circuit comprises:
a signal trigger circuit, comprising two input ends and an output end, the two input ends respectively receiving the scan driving signal and a first control signal, and outputting the scan driving signal when the first control signal satisfies a triggering condition; and
a first logic circuit, comprising two input ends and an output end, one input end being connected to an output end of the signal trigger circuit, the other input end receiving a second control signal, the logic unit outputting a calculated scan driving signal which is obtained by a logical operation of the scan driving signal output by the signal trigger circuit and the second control signal.

15. The display driving circuit according to claim 14, wherein, the first logic circuit is a logic OR gate, in the signal output control circuit connected to the row signal line of the preset row.

16. The display driving circuit according to claim 14, wherein, the first logic circuit is a logic AND gate, in the signal output control circuit connected to the row signal line on any of the remaining rows.

17. A display device, wherein, the display device comprises:
a substrate, the substrate being defined with a display area and a non-display area, the display area being defined with a plurality of display pixels therein; and
a display driving device, configured to drive the display pixels for display, the display driving device comprising a plurality of scan signal output circuits, the plurality of scan signal output circuits outputting scan driving signals to corresponding row signal lines, to drive the display pixels on the row signal lines, according to the control signals of a timing sequence control circuit; each of the scan signal output circuits comprising a signal output control circuit, and by the control of the signal output control circuit, output duration of the scan driving signal being extended, when the scan driving signal is output for a row signal line of a preset row.

18. The display device of claim 17, wherein, the display driving device comprises a driving controller, a scan driving circuit and a data driving circuit, the driving controller outputs a driving control signal, to control the scan driving circuit and the data driving circuit to output corresponding driving signals, to drive the display pixels to work.

19. The display device of claim 18, wherein, the scan driving circuit outputs the scan driving signal, and the scan driving signal is output to the row signal line via the scan signal output circuit.

20. The display device of claim 19, wherein, the driving controller outputs the control signal, and the control signal is output to the scan signal output circuit, to control output of the scan driving signal.
